(19) United States
(12) Patent Application Publication
(10) Pub. No.: US 2018/0033557 A1
(43) Pub. Date: Feb. 1, 2018

(54) NOVEL CAPACITOR PACKAGE STRUCTURE

(71) Applicant: APAQ TECHNOLOGY CO., LTD., Miaoli County (TW)

(72) Inventors: MING-GOO CHIEN, TAICHUNG CITY (TW); MING-TSUNG CHEN, CHANGHUA COUNTY (TW); CHING-FENG LIN, HSINCHU COUNTY (TW)

(21) Appl. No.: 15/362,974

(22) Filed: Nov. 29, 2016

(30) Foreign Application Priority Data
Jul. 29, 2016 (TW) 105124098

(51) Int. Cl. H01G 4/30; H01G 4/008; H01G 4/228; H01G 4/14; H01G 4/33; H01G 4/224

(52) U.S. Cl. CPC H01G 4/306; H01G 4/33; H01G 4/224; H01G 4/228; H01G 4/14; H01G 4/008

(57) ABSTRACT

A novel capacitor package structure of the instant disclosure includes a mutilayer film capacitor, a package unit, a first conductive terminal, and a second conductive terminal. The mutilayer film capacitor includes two terminal electrodes and a mutilayer body between the two terminal electrodes, wherein the mutilayer body includes a plurality of metal layers stacked alternately with a plurality of dielectric layers. The package unit encloses the mutilayer film capacitor. The first conductive terminal and the second conductive terminal are electrically connected to the two terminal electrodes, respectively.

### BACKGROUND OF THE INVENTION

### 1. Field of the Invention

The instant disclosure relates to a capacitor package structure, and more particularly to a high reliability novel capacitor package structure.

### 2. Description of Related Art

Capacitors are commonly used in home appliances, computer motherboards and peripherals, power supplies, communication products and automobiles, and are mainly used to provide a filtering, bypassing, rectifying, coupling, blocking and/or transforming function. There are many different types of capacitors such as aluminum electrolytic capacitor, titanium electrolytic capacitor, multilayer ceramic capacitor, and metalized film capacitor.

The conventional metalized film capacitor includes a plurality of metal films and a plurality of insulation films which are alternately stacked together, wherein each of the metal films can be made of Al, Zn, or any other conductive metal, and each of the insulation films can be made of polypropylene, polystyrene, polyester or methyl methacrylate. However, the conventional metalized film capacitor usually exhibit the following problems: (1) moisture easily enters from outside into the capacitor in a moist environment, and thus can cause corrosion and reduction of lifetime; and (2) the conflict between current ability and pressure resistance cannot be solved, because the thinner metal film may result in bad current ability, and the thicker metal film may result in bad pressure resistance.

### SUMMARY OF THE INVENTION

One aspect of the instant disclosure relates to a reliability novel capacitor package structure which applies an optimized packaged mutilayer film capacitor to enhance the overall performance.

In order to achieve the aforementioned objects, according to an embodiment of the instant disclosure, the novel capacitor package structure comprises a mutilayer film capacitor, a package unit, a first conductive terminal, and a second conductive terminal. The mutilayer film capacitor includes two terminal electrodes and a mutilayer body between the two terminal electrodes, wherein the mutilayer body includes a plurality of metal layers stacked alternately with a plurality of dielectric layers. The package unit encloses the mutilayer film capacitor. The first conductive terminal and the second conductive terminal are electrically connected to the two terminal electrodes, respectively.

In one embodiment, the mutilayer film capacitor further comprises a top protective layer laminated to a top surface of the mutilayer body and a bottom protective layer laminated to a bottom surface of the mutilayer body.

In one embodiment, the first conductive terminal has a first embedded portion enclosed by the package unit, and two opposite ends of the first embedded portion extending away from each other directly contact one of the two terminal electrodes, and wherein the second conductive terminal has a second embedded portion enclosed by the package unit, and two opposite ends of the second embedded portion extending away from each other directly contact another one of the two terminal electrodes.

In one embodiment, the package unit has a top surface, a bottom surface, a first lateral surface, and a second lateral surface, the first lateral surface and the second lateral surface are positioned between the top surface and the bottom surface, and the first lateral surface is opposite to the second lateral surface.

In one embodiment, the two terminal electrodes of the mutilayer film capacitor extend in a direction parallel to the first and second lateral surfaces.

In one embodiment, one end of the first conductive terminal contact one of the two terminal electrodes, and the other end of the first conductive terminal extends outwardly from the first lateral surface and downwardly to contact the bottom surface, and wherein one end of the second conductive terminal contact another one of the two terminal electrodes, and the other end of the second conductive terminal extends outwardly from the second lateral surface and downwardly to contact the bottom surface.

In one embodiment, the first conductive terminal has a first embedded portion enclosed by the package unit and a first exposed portion exposed outside the package unit, the second conductive terminal has a second embedded portion enclosed by the package unit and a second exposed portion exposed outside the package unit, the first and second embedded portions respectively contact the two terminal electrodes, the first exposed portion is bent downward to contact the first lateral surface and the bottom surface, and the second exposed portion is bent downward to contact the second lateral surface and the bottom surface.

In one embodiment, the package unit is made of epoxy resin or silicone.

In one embodiment, the package unit comprises a case for accommodating the mutilayer film capacitor and a cap installed to an opening of the case, the first and second conductive terminals extend in an outward direction from the mutilayer film capacitor to the cap, one of the ends of the first and second conductive terminals respectively contact the two terminal electrodes, and the other end of the first and second conductive terminals protrude out from the cap.

In one embodiment, the extension direction of the first conductive terminal is opposite to that of the second conductive terminal.

Therefore, the novel capacitor package structure comprises a mutilayer film capacitor having a plurality of metal layers stacked alternately with a plurality of dielectric layers, a package unit for enclosing the mutilayer film capacitor, and at least a first and a second conductive terminals for electrically connecting the mutilayer film capacitor to an exterior circuit, such that it has good insulation ability, good waterproof ability, and high pressure resistance, and thus it has good reliability. Moreover, the novel capacitor package structure is capable of satisfying the requirements of different specifications of capacitors, and its usability is thus increased.

To further understand the techniques, means and effects of the instant disclosure, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a schematic view of the novel capacitor package structure according to the first embodiment of the instant disclosure;

FIG. 2 shows a schematic view of the mutilayer film capacitor of the novel capacitor package structure;

FIG. 3 shows a schematic view of the novel capacitor package structure according to the second embodiment of the instant disclosure;

FIG. 4 shows a schematic view of the novel capacitor package structure according to the third embodiment of the instant disclosure;

FIG. 5 shows a schematic view of the novel capacitor package structure according to the fourth embodiment of the instant disclosure; and

FIG. 6 shows a schematic view of the novel capacitor package structure according to the fifth embodiment of the instant disclosure.

### DETAILED DESCRIPTION OF THE PREFERRED EMBODIMENTS

Because the thin film capacitors (e.g. polymer multilayer capacitor), compared with other types of capacitors, can be more easily miniaturized and can have very high capacitance per unit volume, the instant disclosure provides a novel capacitor package structure.

Embodiments of the novel capacitor package structure according to the instant disclosure are described herein. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

### First Embodiment

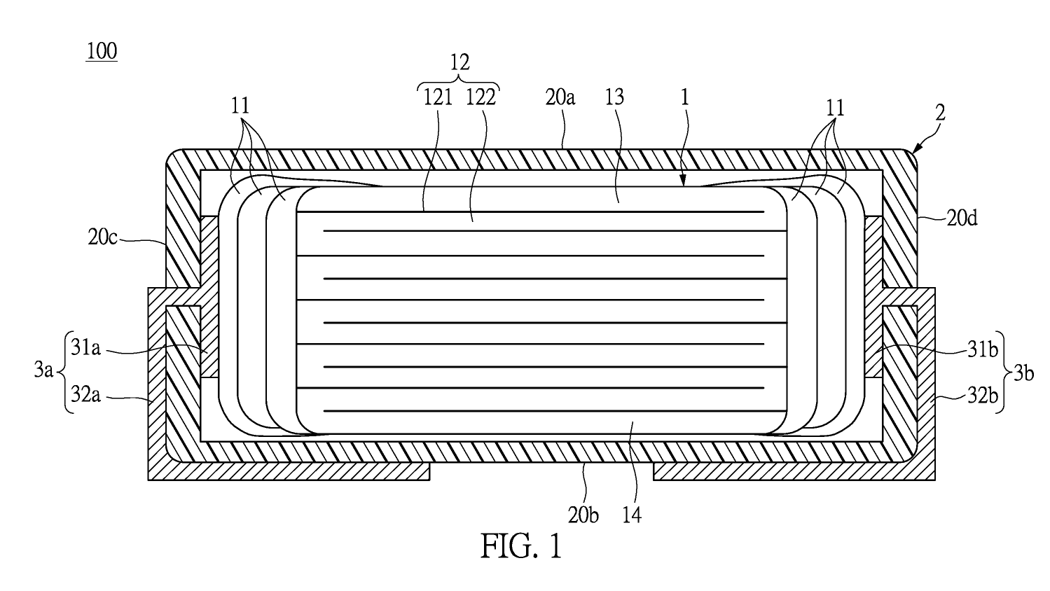

Please refer to FIG. 1, which shows a schematic view of the novel capacitor package structure according to the first embodiment of the instant disclosure. The novel capacitor package structure 100, as shown in FIG. 1, comprises a mutilayer film capacitor 1, a package unit 2, a first conductive terminal 3a, and a second conductive terminal 3b. The mutilayer film capacitor 1 comprises two terminal electrodes 11 and a mutilayer body 12 between the two terminal electrodes 11, wherein the mutilayer body 12 comprises a plurality of metal layers 121 stacked alternately with a plurality of dielectric layers 122. The package unit 2 encloses the mutilayer film capacitor 1. The first conductive terminal 3a and the second conductive terminal 3b are electrically connected to the two terminal electrodes 11, respectively.

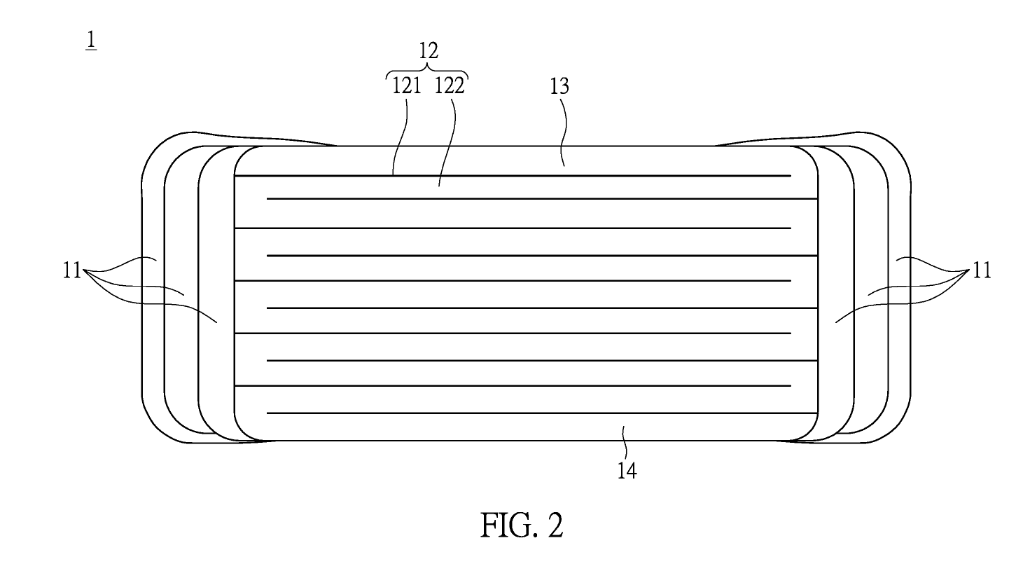

Please refer to FIG. 2. In the instant embodiment, the mutilayer body 12 of the mutilayer film capacitor 1 is plate-shaped, wherein the metal layers 121 can be made of aluminum, and the dielectric layers 122 can be made of acrylic resin (e.g. 1,6-hexanediol diacrylate). Each of the metal layers 121 can be formed by evaporating, and has a thickness in the range between 250 and 300 Å. For forming each of the dielectric layers 122, which has a thickness of about 0.4 μm, the method first deposits a high dielectric constant thin film on the respective metal layer 121, and then cures the high dielectric constant thin film. There is no restriction on formation of the metal layers 121 and the dielectric layers 122.

The two terminal electrodes 11 of the mutilayer film capacitor 1 is stripe-shaped, wherein the manufacturing method thereof comprises forming sputtered metal layers respectively over the two opposite sides of the mutilayer body 12, coating a conductive paste onto each of the sputtered metal layers, curing the conductive pastes, and forming a Sn plating layer respectively over each of the cured conductive pastes. There is no restriction on formation of the two terminal electrodes 11. In various embodiments, each of the two terminal electrodes 11 can be a three-layered structure consisting of an Ag layer, a Ni layer, and a Sn layer which are arranged in an outward direction. Preferably, a top protective layer 13 can be laminated to a top surface of the mutilayer body 12, and a bottom protective layer 14 can be laminated to a bottom surface of the mutilayer body 12. The top and bottom protective layers 13, 14 can be made of acrylic resin (e.g. 1,6-hexanediol diacrylate), having a thickness of about 0.4 μm. For forming the top and bottom protective layers 13, 14, the method comprises forming evaporated resin layers respectively on the top and bottom and curing the evaporated resin layers. There is no restriction on formation of the top and bottom protective layers 13, 14.

The number of layers of the metal layers 121 and the dielectric layers 122 required in the mutilayer body 12 can be adjusted according to the desired capacitance. For example, forty-seven hundred metal layers 121 and forty-seven hundred dielectric layers 122 can be alternatively stacked together, and the semi-finished product can have a predetermined size by cutting exactly.

Referring to FIGS. 1 and 2, the package unit can be made of epoxy resin or silicone, having a top surface 20a, a bottom surface 20b, a first lateral surface 20c, and a second lateral surface 20d, wherein the first lateral surface 20c and the second lateral surface 20d are positioned between the top surface 20a and the bottom surface 20b, and the first lateral surface 20c is opposite to the second lateral surface 20d. The mutilayer film capacitor 1 is completely surrounded and enclosed by the package unit 2 such that it has good insulation ability, good waterproof ability, and high pressure resistance, and thus it has good reliability.

The first conductive terminal 3a and the second conductive terminal 3b are configured to electrically connect the mutilayer film capacitor 1 to an exterior circuit. Specifically, one end of the first conductive terminal 3a contacts one of the two terminal electrodes 11, and the other end of the first conductive terminal 3a extends outwardly from the first lateral surface 20c and downwardly to contact the bottom surface 20b. One end of the second conductive terminal 3b contacts another one of the two terminal electrodes 11, and the other end of the second conductive terminal 3b extends outwardly from the second lateral surface 20d and downwardly to contact the bottom surface 20b.

Furthermore, the two terminal electrodes 11 of the mutilayer film capacitor 1 extend in a direction parallel to the first and second lateral surfaces 20c, 20d. The first conductive terminal 3a has a first embedded portion 31a enclosed by the package unit 2 and a first exposed portion 32a exposed outside the package unit 2. Two opposite ends of the first embedded portion 31a extending away from each other directly contact one of the two terminal electrodes 11, or they can be fixed to the respective terminal electrode 11 by a conductive paste (not shown). The first exposed portion 32a extends outwardly from the first embedded portion 31a and is bent downward to contact the first lateral surface 20c and the bottom surface 20b. Similarly, the second conductive terminal 3b has a second embedded portion 31b enclosed by the package unit 2 and a second exposed portion 32b exposed outside the package unit 2. Two opposite ends of the second embedded portion 31b extending away from each other directly contact another one of the two terminal electrodes 11, or they can be fixed to the respective terminal electrode 11 by a conductive paste (not shown). The second exposed portion 32b extends outwardly from the second embedded portion 31b and is bent downward to contact the second lateral surface 20d and the bottom surface 20b. In various embodiments, each of the first and second conductive terminals 3a, 3b has a continuous bent section configured to increase the length of any inadvertent water entry pathway, and thus to prevent water entering from outside environment.

In practice, the novel capacitor package structure 100 can selectively include functional components such as an over-current protection component and an over-heat protection component. These technical details are well known in contemporary technology, and no further elaboration is needed.

### Second Embodiment

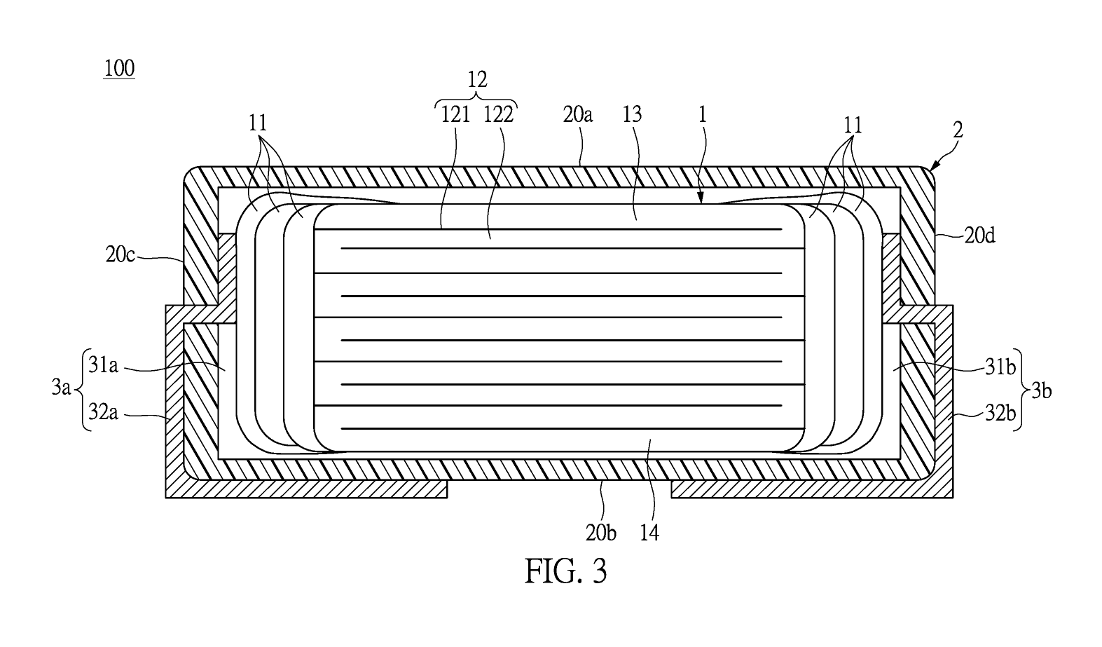

Please refer to FIG. 3, which shows a schematic view of the novel capacitor package structure according to the second embodiment of the instant disclosure. As shown in FIG. 3, the second embodiment is substantially the same as the first embodiment, except that the first embedded portion 31a has only one end that extends in a direction equal to the first exposed portion 32a and directly contacts one of the two terminal electrodes 11, and the second embedded portion 31b has only one end that extends in a direction equal to the second exposed portion 32b and directly contacts another one of the two terminal electrodes 11.

### Third Embodiment

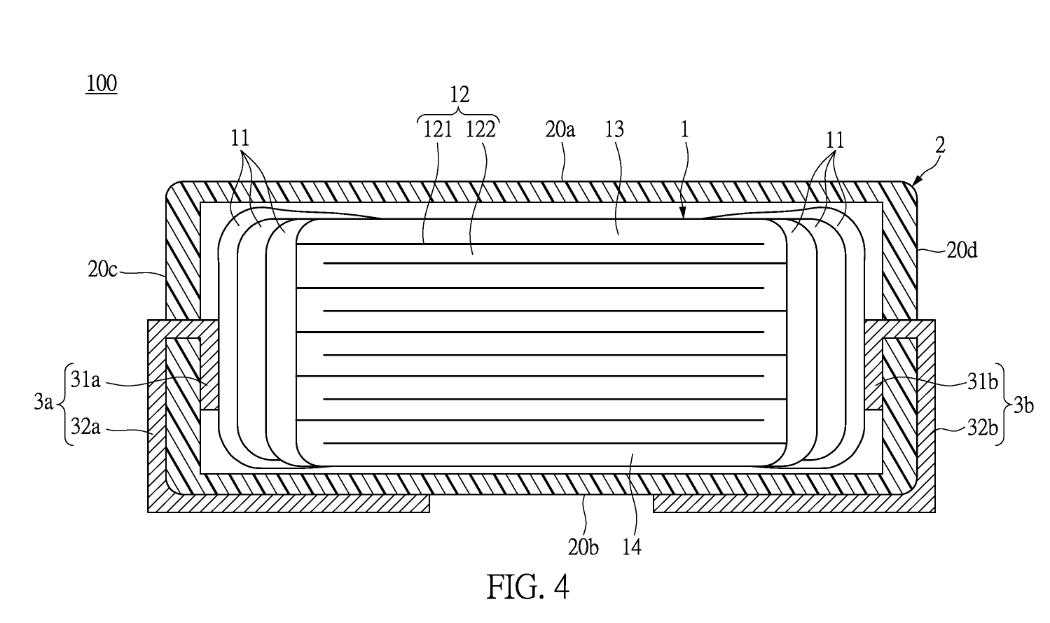

Please refer to FIG. 4, which shows a schematic view of the novel capacitor package structure according to the third embodiment of the instant disclosure. As shown in FIG. 4, the third embodiment is substantially the same as the second embodiment, except that the first embedded portion 31a has only one end that extends in a direction opposite to the first exposed portion 32a and directly contacts one of the two terminal electrodes 11, and the second embedded portion 31b has only one end that extends in a direction opposite to the second exposed portion 32b and directly contacts another one of the two terminal electrodes 11.

### Fourth Embodiment

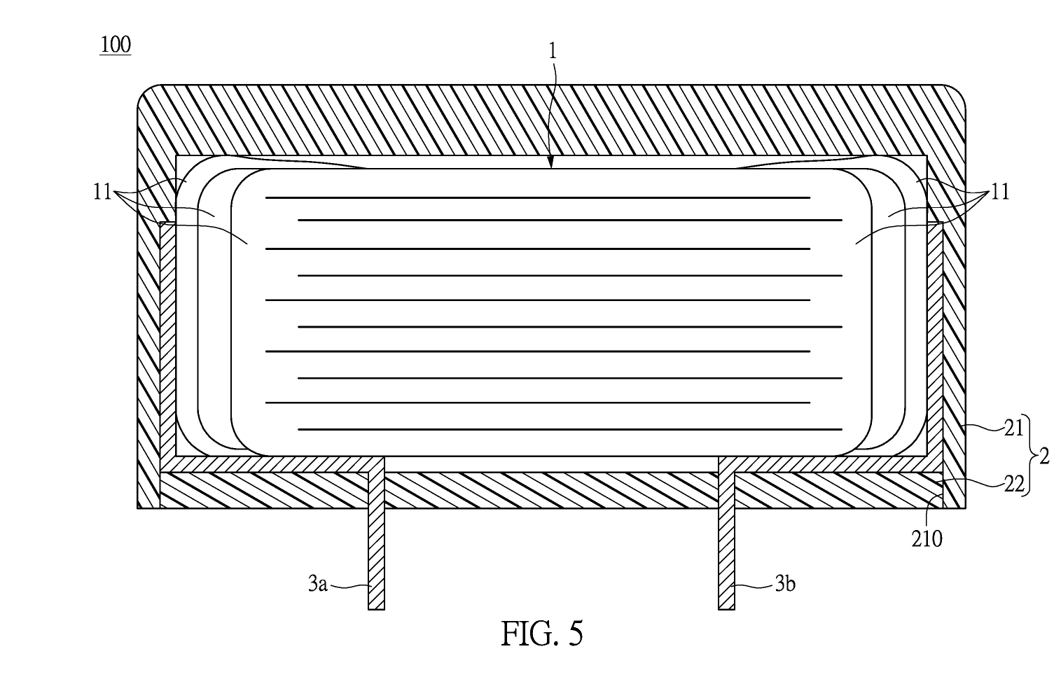

Please refer to FIG. 5, which shows a schematic view of the novel capacitor package structure according to the fourth embodiment of the instant disclosure. As shown in FIG. 5, the fourth embodiment is substantially the same as the first embodiment, except that the package unit 2 of the novel capacitor package structure 100 comprises a case 21 and a cap 22, and the mutilayer film capacitor 1 is completely surrounded and enclosed by the case 21 and the cap 22.

Specifically, the case 21 is configured to accommodate the mutilayer film capacitor 1, having an opening 210. The cap 22 can be made of colloidal particle material, and is installed to the opening 210 to seal the mutilayer film capacitor. For providing an electrical connection with a wirebond component, the first and second conductive terminals 3a, 3b extend in an outward direction from the mutilayer film capacitor 1 to the cap 22, wherein one of the ends of the first and second conductive terminals 3a, 3b respectively contact the two terminal electrodes 11, and the other ends of the first and second conductive terminals 3a, 3b protrude out from the cap.

### Fifth Embodiment

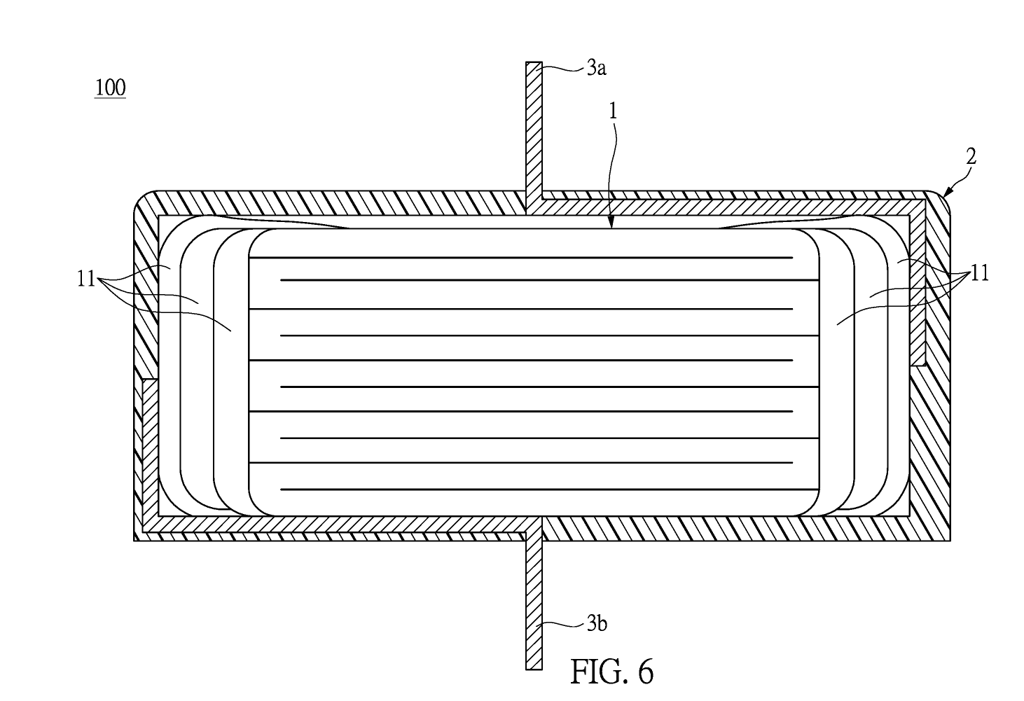

Please refer to FIG. 6, which shows a schematic view of the novel capacitor package structure according to the fifth embodiment of the instant disclosure. As shown in FIG. 6, the fifth embodiment is substantially the same as the first embodiment, except that the extension direction of the first conductive terminal 3a is opposite to that of the second conductive terminal 3b.

Based on the above, the benefits of the present invention include: The novel capacitor package structure comprises a mutilayer film capacitor having a plurality of metal layers stacked alternately with a plurality of dielectric layers, a package unit for enclosing the mutilayer film capacitor, and at least a first and a second conductive terminal for electrically connecting the mutilayer film capacitor to an exterior circuit, such that it has good insulation ability, good waterproof ability, and high pressure resistance, and thus it has good reliability. Moreover, the novel capacitor package structure is capable of satisfying the requirements of different specifications of capacitors, and its usability is thus increased.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A novel capacitor package structure, comprising:
a mutilayer film capacitor comprising two terminal electrodes and a mutilayer body between the two terminal electrodes, wherein the mutilayer body comprises a plurality of metal layers stacked alternately with a plurality of dielectric layers;
a package unit enclosing the mutilayer film capacitor; and
a first conductive terminal and a second conductive terminal electrically connected to the two terminal electrodes, respectively.

2. The novel capacitor package structure according to claim 1, wherein the mutilayer film capacitor further comprises a top protective layer laminated to a top surface of the mutilayer body and a bottom protective layer laminated to a bottom surface of the mutilayer body.

3. The novel capacitor package structure according to claim 1, wherein the first conductive terminal has a first embedded portion enclosed by the package unit, and two opposite ends of the first embedded portion extending away from each other directly contact one of the two terminal electrodes, and wherein the second conductive terminal has a second embedded portion enclosed by the package unit, and two opposite ends of the second embedded portion extending away from each other directly contact another one of the two terminal electrodes.

4. The novel capacitor package structure according to claim 1, wherein the package unit has a top surface, a bottom surface, a first lateral surface, and a second lateral surface, the first lateral surface and the second lateral surface are positioned between the top surface and the bottom surface, and the first lateral surface is opposite to the second lateral surface.

5. The novel capacitor package structure according to claim 4, wherein the two terminal electrodes of the mutilayer film capacitor extend in a direction parallel to the first and second lateral surfaces.

6. The novel capacitor package structure according to claim 5, wherein one end of the first conductive terminal contacts one of the two terminal electrodes, and the other end of the first conductive terminal extends outwardly from the first lateral surface and downwardly to contact the bottom surface, and wherein one end of the second conductive terminal contacts another one of the two terminal electrodes, and the other end of the second conductive terminal extends outwardly from the second lateral surface and downwardly to contact the bottom surface.

7. The novel capacitor package structure according to claim 5, wherein the first conductive terminal has a first embedded portion enclosed by the package unit and a first exposed portion exposed outside the package unit, the second conductive terminal has a second embedded portion enclosed by the package unit and a second exposed portion exposed outside the package unit, the first and second embedded portions respectively contact the two terminal electrodes, the first exposed portion is bent downward to contact the first lateral surface and the bottom surface, and the second exposed portion is bent downward to contact the second lateral surface and the bottom surface.

8. The novel capacitor package structure according to claim 1, wherein the package unit is made of epoxy resin or silicone.

9. The novel capacitor package structure according to claim 1, wherein the package unit comprises a case for accommodating the mutilayer film capacitor and a cap installed to an opening of the case, the first and second conductive terminals extend in an outward direction from the mutilayer film capacitor to the cap, one of the ends of the first and second conductive terminals respectively contacts the two terminal electrodes, and the other end of the first and second conductive terminals protrude out from the cap.

10. The novel capacitor package structure according to claim 1, wherein the extension direction of the first conductive terminal is opposite to that of the second conductive terminal.
